(19) United States
(12) Patent Application Publication
(10) Pub. No.: US 2010/0216006 A1
(43) Pub. Date: Aug. 26, 2010

(54) REDOX BATTERY

(76) Inventor: Klaus Rennebeck, Wendlingen (DE)

Correspondence Address: OSHA LIANG L.L.P., TWO HOUSTON CENTER, 909 FANNIN, SUITE 3500, HOUSTON, TX, 77010, US

(21) Appl. No.: 12/669,007

(22) PCT Filed: Jul. 16, 2008
(86) PCT No.: PCT/DE2008/001174

§ 371 Date: Apr. 28, 2010

(30) Foreign Application Priority Data
Jul. 16, 2007 (DE) 10 2007 034 700.8

(51) Int. Cl. H01M 6/24

(52) U.S. Cl. 429/105

(57) ABSTRACT

The invention relates to a redox battery comprising a proton-permeable membrane, a first electrolyte (5) and a second electrolyte (6), as well as a first electrode (7) and a second electrode (8). The membrane is designed as a hollow profiled member (4), the electrolytes (5, 6) are provided in a liquid form at least in the operating state, the first electrolyte (5) and the first electrode (7) are disposed inside the hollow profiled member (4), the second electrolyte (6) is externally arranged around the hollow profiled member (4), and the second electrode (8) is externally placed on or near the hollow profiled member (4). Furthermore, a plurality of electrodes (7 or 8) are connected in parallel, and the interior spaces of the hollow profiled members (4) are fluidically interconnected.

The invention relates to a redox battery with the features according to the preamble of claim 1.

In the so called redox reaction, one reactant transfers electrons to the other reactant. Thus, a loss of electrons (oxidation) takes place at one reactant and a gain of electrons (reduction) takes place at the other reactant. The flux of electrons may be used as energy. Redox reactions of the mentioned kind are employed, for example, within batteries and accumulators.

An example of a redox battery is known from document WO 03/019714. As disclosed therein, a cell divided into two parts by an ion conducting membrane and having two kinds of electrolytes is provided, each of the electrolytes being circulated in a circuit having one container by pumps. In each half of the cell, there is provided an electrode from which electrons can be picked off and into which electrons can be fed in, respectively, while exchange of protons takes place through the membrane. As a “positive” electrolyte, there is provided an electrolyte having a polyhalide/halide redox system, whereas as a “negative” electrolyte, there is provided an electrolyte comprising a V(III)/V(II) redox system.

Conventional redox batteries still leave amendments to be desired.

It is therefore the object of the invention to improve a redox battery of the kind mentioned above.

According to the invention, the object is achieved by a redox battery having the features of claim 1. Advantageous embodiments are given in the dependent claims.

According to the invention, there is provided a redox battery having a proton-permeable membrane, a first electrolyte and a second electrolyte, a first electrode and a second electrode, the membrane being formed as a hollow profiled member, the electrolytes being provided in liquid form at least in an operating state, the first electrolyte and the first electrode being disposed within the hollow profiled member, the second electrolyte being externally arranged around the hollow profiled member, the second electrode being externally placed on or near the hollow profiled member, a plurality of electrodes being connected in parallel and interior spaces of the hollow profiled members are fluidically interconnected.

Preferably, the hollow profiled member comprises a hydraulically equivalent inner diameter of 6 μm to 10 mm, especially preferred of 50 μm to 8 mm, in particular preferred of 500 μm to 5 mm.

A wall thickness of the hollow profiled member is preferably 0.1 μm to 1.5 mm, especially preferred 0.1 μm to 1 mm, in particular preferred 0.1 μm to 0.5 mm, with the variation of the wall thickness lying preferably below +/−6%.

The operation temperature of the battery is preferably below 100° C., but batteries having higher operation temperatures are possible. However, in certain applications, for example for use in a laptop, temperature problems may arise, and therefore operation temperatures as low as possible are preferred.

The electrolytes are preferably electrolytes comprising vanadium salt, especially in connection with citric acid and/or oxalic acid.

As to further possible compositions of the electrolytes, reference is made to document EP 1 143 546 A1 the disclosure of which in connection with electrolytes is explicitly included herein by reference. Especially suitable are aqueous solutions including vanadium salts, particularly preferred in connection with citric acid and/or oxalic acid. Furthermore, urea, polyvinyl alcohol can be taken into account, also in connection with vanadium salt, citric acid and/or oxalic acid. The electrolyte may also be an electrolyte which is a melt at normal operating temperatures of the battery. Especially, that melt solidifies if the battery is out of use.

The membrane which forms the hollow profiled members preferably contains gelatine, polyvinyl alcohol, polyester, polymer, polytetraflouroethylene (PTFE) and/or polyetheretherketone (PEEK). Particularly suitable as materials for the membrane are polyester, polymer, fluorinated polymer, suffocated polymer, especially suffocated tetrafluoroethylene polymer, PTFE, PEEK, wherein that listing is not exclusive.

Especially suitable are membranes which are commercially available under the trade names Nafion®, Gore Select®, 3M®, Celanese®, Satorius®.

The membranes can also be made from stabilized zirconium oxide and/or titan oxide and/or silicon, especially in form of diatomaceous earth, and have the shape of sintered profiled members, hollow profiled members or foils or in the shape of so called green bodies with a fraction of nano particles in relation to the total fraction of solid particles lying up to 80%. Here, a polymer, especially a so called bio polymer, is preferably provided as a binding agent serving as a proton conductor.

Especially, membranes may also be constituted by textile laminar members, particularly in form of a non-woven, formed from micro fibers or micro hollow fibers with the fibers being made preferably by the above mentioned materials zircon oxide and/or titan oxide and/or silicon oxide.

Particularly preferred, the membrane consists of citric acid in connection with nano particles, especially silicon, silicon oxide, magnesium oxide, magnesium, with faces of the membranes being in contact with the electrolytes having the lotus effect.

Especially carbon fibers and/or metal fibers are provided as electrodes. Those may extend parallel to the central longitudinal axis of the membrane formed as a hollow profiled member. The fibers may be arranged running separately from a surface of the hollow profiled member or along at the surface of the hollow profiled member, inside and outside, respectively, of the surface.

Particularly preferred, the electrodes are formed with open cells which means that the surface structure of them is enlarged.

The hollow profiled members can be disposed within a frame in the shape of a circular ring, the ends of the hollow profiled members being bound-in in such a way that a stable, self-supporting ring is formed at the outer peripheral surface of which the open micro hollow fiber ends are exposed or can at least be contacted. The frame may constitute a flat circular ring, as seen in cross sectional view. The electrodes are led out of that frame, the electrodes being connected to the interior surface of the hollow profiled member or being arranged in the interior space of the hollow profiled members being led out individually. The individual electrodes may be combined—if applicable also integrated in the frame. The electrodes arranged outside of the hollow profiled members are preferably also combined and led out.

As an alternative, the frame may also have the form of a polygon, in particular a rectangle, wherein the hollow fiber ends are bound-in in such a way that a stable, self-supporting polygonal, in particular rectangular, frame is formed, at the outer peripheral surface of which the open ends of the hollow profiled members are exposed. In this case, the individual hollow profiled members can be arranged either parallel to each other or crossing each other, wherein the lengths of the hollow profiled members preferably corresponds approximately to the length and the width, respectively, of the frame.

Preferably, the hollow profiled members have a length of approximately 5 mm to 1000 mm, particularly preferred 30 mm to 300 mm.

Values of between approximately 1 mm and 35 mm have proven particularly suitable for the thickness of the frame, so that the function of the frame as a shape stabilizer is fulfilled. Preferably, the height of the frame is approximately 0.5 mm to 15 mm. This height is sufficient in order to accommodate several layers of hollow profiled members one above the other.

Such a frame is suitable for a stack of a plurality of partial batteries, wherein the individual partial batteries may be connected in series in order to increase the voltage and/or in parallel in order to increase the current.

According to a preferred embodiment, the frame may be formed so as to be flexible about an axis which runs parallel to the longitudinal axis of the hollow profiled members.

In the case of a rigid, in the stretched status rectangular shaped frame as well as in case of a corresponding plastically or elastically deformable frame, the frame may have any shape in the viewing direction of the openings of the hollow profiled members, for example the shape of a C.

Particularly preferred, at least two frames with hollow profiled members are connected in series in order to increase the voltage.

Preferably, the hollow profiled member may be spun, extruded, or wound from a foil. Alternatively, a hollow profiled member may be composed of two or more open spun or extruded profiled members. Any other methods of manufacturing are possible.

Especially in the case of manufacturing from foils, in order to stabilize those ones and/or in order to mount or form the electrodes, the surface may be printed on one or both sides or otherwise coated at least sectionally, wherein the coating is particularly preferred formed open-celled. The coating may contain a catalyst, if applicable. Moreover, a coating protects the foil.

Preferably, at least two containers for storage of the first and the second electrolytes are provided, wherein the containers are particularly preferred formed to be exchangeable. The containers are preferably integrated in electrolyte circuits in which the corresponding electrolyte is conveyed by a pump so that sufficient exchange is possible within the inner space of the battery. Instead of pumping, the conveyance of one or both of the electrolytes can also be effected purely by gravitation. In this connection, already small differences in height of the fluid levels are sufficient in order to provide for a sufficient exchange of electrolyte, especially in the interior of the hollow profiled members.

A redox battery according to the invention may preferably be used as a drive for an electric vehicle, plane or ship, however other uses, for example for laptops, are possible.

Particularly preferred, the central longitudinal axes of the membranes formed as hollow profiled members are arranged running vertically in relation to the ordinary orientation of the battery.

In the following, the invention is explained in more detail with the aid of several exemplary embodiments and variants, partly with reference to the enclosed drawing. In the drawing:

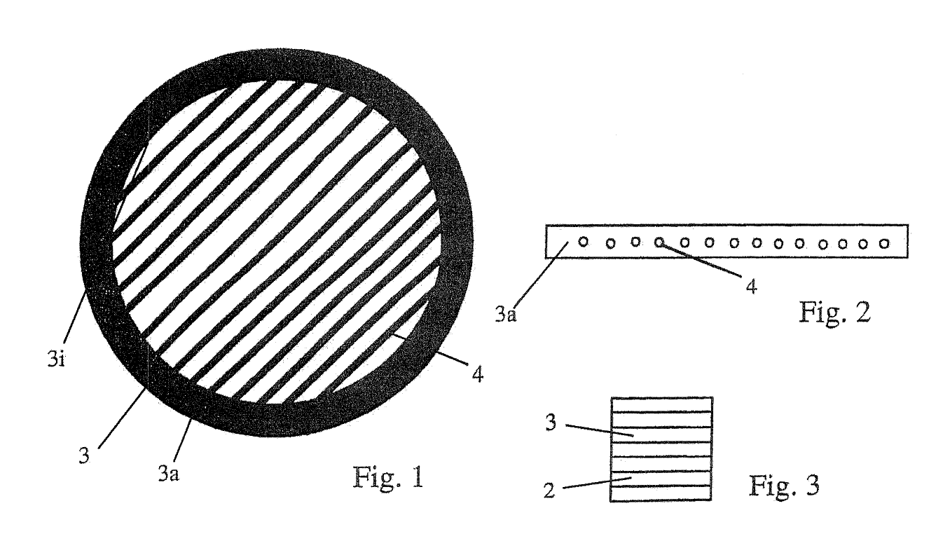

FIG. 1 shows a schematically depicted arrangement of membrane hollow profiled members in a frame,

FIG. 2 shows a schematic side view of the frame with hollow profiled members of FIG. 1,

FIG. 3 shows a schematic depiction of a battery from a side,

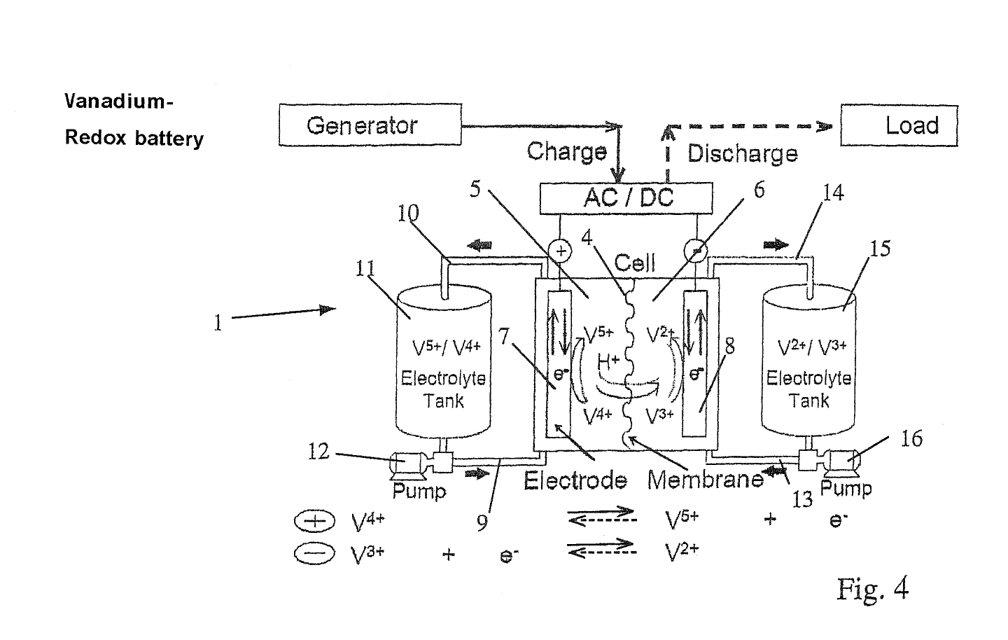

FIG. 4 shows a vanadium redox battery for explanation of the function, and

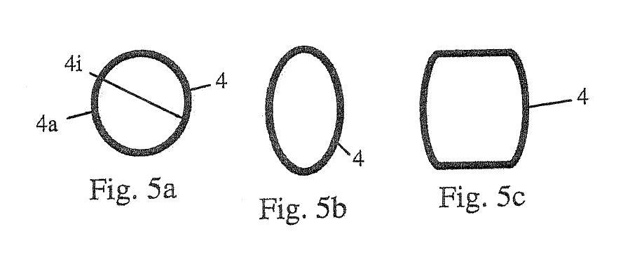

FIGS. 5a, 5b, 5c show different exemplary cross sections of membrane hollow profiled members.

A redox battery 1 according to a first embodiment is formed of two partial batteries 2 connected in series for rise of voltage reasons. Each partial battery 2 comprises a frame 3, an upper and a lower frame cover (not depicted), hollow profiled members 4 kept within the frame 3 in the region of their ends, as well as two electrolytes 5 and 6. Here, the first electrolyte 5 is situated within the hollow profiled members 4, and the second electrolyte 6 is situated outside the hollow profiled members 4 within the corresponding frame 3.

In this case, the membranes, which form the hollow profiled members 4, consist of Nafion®. The hollow profiled member 4 essentially has the shape of a hollow cylinder, wherein the free inner diameter is 1 mm in this case. The wall thickness is approximately 10 μm, wherein the variation of the wall thickness (as taken across the length and the perimeter) lies below +/−6%. An essentially endless hollow profiled member is produced by extrusion in a per se known manner, and the individual hollow profiled members 4 are cut off. Into the hollow space of each hollow profiled member 4, a first electrode 7 is inserted. Subsequently, the hollow profiled members 4 as well as metallic fibers (not depicted) which form the second electrodes 8, are cast in a material forming the frame 3, in the present case in insulating plastics. Subsequently, the second electrodes 8 as well as outer faces 4a of the hollow profiled members 4 are connected with an inner face 3i of the frame 3 in an electrically conductive manner, and correspondingly, the first electrodes 7 as well as inner faces 4i of the hollow profiled members 4 are connected with an outer face 3a of the frame 3 in an electrically conductive manner, wherein the inner face 3i and the outer face 3a of the frame 3 are electrically isolated against each other. The connection of the individual partial batteries 2 in series for increase of the battery voltage is performed in a per se known manner. The partial batteries 2 are put into a casing (not shown).

In the present case, the electrolytes are aqueous solutions of vanadium salts with citric acid and oxalic acid. In this connection, the vanadium is present in ionized form, in the case of the first electrolyte 5 in the form V⁵⁺/V⁴⁺, and in the case of the second electrolyte 6 in the form V²⁺/V³⁺.

After mounting of the partial battery 2, the filling of the hollow profiled members 4 takes place via a feed line 9, and the discharge of air contained in the hollow profiled members 4 takes place via a discharge line 10 until all of the air has been removed from the system. The feed line 9 and the discharge line 10 are connected with a first container 11, wherein conveyance of the first electrolyte 5 is effected by a fist pump 12. Moreover, filling of the interior space of the frame 3 is effected with the second electrolyte 6 which essentially completely fills the volume within the frame. Via a feed line 13 and a discharge line 14, the interior space of the frame 3 is connected to a second container 15 which stores the second electrolyte 6. Conveyance of the second electrolyte 6 is effected by a second pump 16.

By means of one partial battery 2, the principal construction relating to power generation is shown in FIG. 4, wherein the membrane forming the hollow profiled member 4 is depicted as an undulated wall. The direct voltage generated by the redox battery 1 may be transformed into alternating voltage by a voltage transformer DC/AC, if necessary. The discharge process “Discharge” is indicated by a dashed arrow, the charging by “Load”. In the reverse case, a generator “Generator” charging “Charge” generates an alternating voltage which is transformed into a direct voltage in a voltage transformer AC/DC, which voltages serves for loading the battery 1.

The first container 11 which, in the present case, contains as the first, positive electrolyte 5 vanadium in the form V⁵⁺/V⁴⁺, is part of a kind of circuit, conveyed by the first pump 12 which, in the present case, supplies the first electrolyte 5 to the inner space of the hollow profiled member. Correspondingly, the second container 15 which, in the present case, contains as the second, negative electrolyte 6 vanadium in the form V²⁺/V³⁺, is part of a kind of circuit, conveyed by the second pump 16 which, in the present case, supplies the second electrolyte 6 to the region surrounding the hollow profiled members 4.

For charging the battery 1 according to the corresponding redox reaction depicted on the left side of FIG. 4 which corresponds to the inner spaces of the hollow profiled members, V⁴⁺ is oxidized to V⁵⁺ in order to release an electron e⁻. That electron e⁻ is supplied to the other side depicted at the right side of FIG. 4 which corresponds to the surrounding of the hollow profiled members 4, after having passed an outer (loading) current circuit. That electron e⁻ reduces V³⁺ to V²⁺. During the charging redox reaction, surplus protons H+ are generated on the side depicted right-hand in FIG. 4 corresponding to the outer surrounding of the hollow profiled members 4. Via the membrane (hollow profiled member 4) which is permeable for those protons H+, but is impermeable for the electrons e⁻, they arrive within the inner space of the hollow profiled member in order to keep electric neutrality there. The redox reaction proceeds exactly the other way round, if the battery 1 is operating, i.e. if a load “Load” is connected to the outer current circuit.

According to an alternative to the first embodiment not shown in the drawing, the frame is not formed annularly but as a rectangle hollow profiled member, i.e. all of the hollow profiled members kept by the frame have the same lengths.

FIGS. 5a, 5b, and 5c show various cross sections of hollow profiled members 4 in an exemplary manner. Thus, especially hollow profiled members essentially in the form of a hollow cylinder (FIG. 5a), elliptical hollow profiled members (FIG. 5b), and rounded rectangular hollow profiled members (FIG. 5c) are possible, however also any other polygonal hollow profiled members are possible, for example. Further, the hollow profiled members do not necessarily need to be produced “in one piece”. Thus, especially hollow profiled members composed of two C-shaped profiled members are possible as well. Such a composed hollow profiled member is advantageous in connection with the insertion of the internally placed electrode due to the fact that the electrode can be placed in the inner profiled C-member before the profiled member of the second profiled C-member which slightly encompasses the first profiled C-member with its long side ends, is closed. In the following, the hydraulically equivalent diameter is taken as diameter of non circular cross sections, even if not explicitly mentioned.

For a more simple connection of the individual hollow profiled members, the hollow profiled members may also be formed slightly shorter than the corresponding dimension of the frame, wherein in the outer face of the frame circular recesses around the end of the hollow profiled members may be provided which serve for the connection of outer lines as well as for the current feedthrough of the electrons.

According to one application, such a redox battery having a voltage of approximately 42 V may be used for a electric car, wherein electric motors in the form of wheel hub electric motors are directly integrated in the wheels. Due to the arrangement of the hollow profiled members within a liquid, the stress on the hollow profiled members due to acceleration, deceleration and especially unevenness of the road is relatively low. The containers serving as tanks may be simply exchanged for “refueling” if the corresponding old electrolyte is sucked off. Further, in the case such electric cars, braking energy can be used in a simple, per se known manner for charging the battery by inversion of the direction of the current flux, so that the energy consumption can be optimized. In this connection, the storage capacity of the battery is so high that the entrainment of fuel converting apparatuses for generation of electric energy can be dispensed with.

Corresponding applications are of course possible for any other means of transport, especially for driving rail vehicles, ships or airplanes.

According to a second embodiment, which essentially corresponds to the first embodiment in terms of its construction, a PEEK foil, as it is used as a PEM foil in fuel cells, for example, is provided as the membrane forming the hollow profiled members, which is wound to form tubes. In this connection, thin metal stripes are applied, for example printed, directly on the PEEK foil on both sides thereof, which metal stripes serve as electrodes. In the present case, the foil thickness is 0.5 mm with dimensional variations of at most +/−3%, the hydraulically equivalent diameter of the hollow profiled members which have only approximately the shape of a hollow cylinder being 5 mm in the present case. The winding of the hollow profiled members is carried out in a coil-like manner so that the hollow profiled members can be produced “endlessly” and be cut to the desired length. The alongside edges of the foil are bond with an solvent in the present case. The PEEK foil is designed so that no embedded components of the foil can be dissolved out by water. Further, the foil is proton-conducting and separates the anode from the cathode.

The ends of the hollow profiled members are held in a rectangular frame, wherein the connections for the electrolyte flux of the first electrolyte through the interior spaces of the hollow profiled members correspond to those ones of the first embodiment. In the interior of the frame, the second electrolyte is arranged outside around the hollow profiled members. In the present case, the frame has a length of 300 mm, a width of 200 mm and a height of 20 mm. Ten frames are combined to form a redox battery in the present case, wherein the partial batteries are connected in series. Aqueous solutions of a vanadium salt in sulfurous acid serve as electrolytes in the present case, wherein the concentration of sulfate ions lies in the range of 3 mol/l to 4 mol/l.

According to a further embodiment which is not shown in the drawing, the hollow profiled members are arranged curved in U-shape, wherein the open ends are accommodated in a frame at which corresponding connections for feeding in and discharging the electrolyte are provided. The hollow profiled members are arranged so that, in the present case, the openings for feeding are arranged on a circular ring outside the openings for discharging which are also arranged on a circular ring. Via circular ring-shaped gaps between the outer face of the frame and a counter element, a common feed of all partial fluxes to the hollow profiled members as well as a common discharge thereof take place.

In the region of the branches and in the U-shaped region, the hollow profiled members are freely arranged within the second electrolyte, i.e. they are passed extensively by the latter. The frame is arranged in a tubular casing and closed by a lid, wherein the feed of the second electrolyte takes place via that lid. The discharge of the second electrolyte takes place via a central opening in the frame in this case.

### LIST OF REFERENCE SIGNS

1 redox battery
2 partial battery
3 frame
4 hollow profiled member
5 first electrolyte
6 second electrolyte
7 first electrode
8 second electrode
9 feed line
10 discharge line
11 first container
12 first pump
13 feed line
14 discharge line
15 second container
16 second pump

1. A redox battery having a proton-permeable membrane, a first electrolyte and a second electrolyte, a first electrode and a second electrode, wherein the membrane is formed as a hollow profiled member, the electrolytes are provided in liquid form at least in an operating state, the first electrolyte and the first electrode are disposed within the hollow profiled member, the second electrolyte is externally arranged around the hollow profiled member, the second electrode is externally placed on or near the hollow profiled member, a plurality of electrodes are connected in parallel and interior spaces of the hollow profiled members are fluidically interconnected.

2. The battery according to claim 1, characterized in that the hollow profiled member has a hydraulically equivalent diameter of 6 μm to 10 mm, particularly from 500 μm to 5 mm.

3. The battery according to claim 1, characterized in that the wall thickness of the hollow profiled member is 0.1 μm to 1.5 mm, particularly 0.1 μm to 0.5 mm, wherein the variation of the wall thickness is below +/−6%.

4. The battery according to claim 1, characterized in that the operating temperature of the battery lies below 100° C.

5. The battery according to claim 1, characterized in that the first and second electrolytes contain vanadium salt, particularly in connection with citric acid and/or oxalic acid.

6. The battery according to claim 1, characterized in that the membrane contains gelatine, polyvinyl alcohol, polyester, polymer, polytetraflouroethylene (PTFE) and/or polyetheretherketone (PEEK).

7. The battery according to claim 1, characterized in that the membrane consists of citric acid in connection with nano particles, especially silicon, silicon oxide, magnesium oxide, magnesium, with faces of the membranes being in contact with the electrolytes having the lotus effect.

8. The battery according to claim 1, characterized in that the membrane consists of a suffocated polymer, especially suffocated tetrafluoroethylene polymer.

9. The battery according to claim 1, characterized in that carbon fibers and/or metal fibers are provided as electrodes and/or for providing electric contact.

10. The battery according to claim 9, characterized in that the electrodes are open-celled.

11. The battery according to claim 1, characterized in that the hollow profiled member is provided at least sectionally with an open-celled coating.

12. The battery according to claim 1, characterized in that a plurality of the membranes being formed as hollow profiled members are arranged and held at their ends within a frame.

13. The battery according to claim 12, characterized in that at least two frames with hollow profiled members are connected in series in order to increase voltage.

14. The battery according to claim 1, characterized in that the hollow profiled member is spun, extruded or wound from a foil or that the hollow profiled member is composed of two or more open profiled members.

15. The battery according to claim 1, characterized in that at least two containers are provided for storage of the first and second electrolytes.

16. The battery according to claim 15, characterized in that the containers are exchangeable.

17. The battery according to claim 1, characterized in that central longitudinal axes of the membranes being formed as hollow profiled members are arranged running vertically during ordinary operation of the battery.

18. A drive for an electric vehicle, plane or ship, comprising a battery according to claim 1.

19. The drive according to claim 18, characterized in that central longitudinal axes of the membranes being formed as hollow profiled members are arranged running vertically.
